(19) United States
(12) Patent Application Publication
(10) Pub. No.: US 2008/0209999 A1
(43) Pub. Date: Sep. 4, 2008

(54) Aircraft Takeoff/Landing Time Measuring Method and Aircraft Takeoff/Landing Management Method Using the Method

(75) Inventors: Shinji Ohhashi, Chiba (JP); Kouichi Yamashita, Tokyo (JP); Yoshio Tadahira, Chiba (JP)

Correspondence Address: JORDAN AND HAMBURG LLP, 122 EAST 42ND STREET, SUITE 4000, NEW YORK, NY, 10168, US

(73) Assignee: NITTOBO ACOUSTIC ENGINEERING CO., LTD., Simda-ku, Tokyo (JP)

(21) Appl. No.: 11/632,980

(22) PCT Filed: Jul. 15, 2005
(86) PCT No.: PCT/JP2005/013191

§ 371 Date: Dec. 18, 2007

(30) Foreign Application Priority Data
Jul. 20, 2004 (JP) 2004-210934
Sep. 1, 2004 (JP) 2004-254935

(51) Int. Cl. G01C 23/00

(52) U.S. Cl. 73/178 T

(57) ABSTRACT

There is provided a method for automatically measuring the takeoff/landing time of an aircraft which has been performed conventionally by human visual observation. Furthermore, there is provided an aircraft takeoff/landing management method using the method. An ACAS signal transmitted from an aircraft transponder is received and a vertical status code contained in the signal or a barometric altimeter indication value change is used to detect/measure a takeoff/landing time. Moreover, the signal is classified according to the aircraft unique identifier contained in the signal. Thus, takeoff/landing information on a plenty of aircraft can be acquired and managed.

### TECHNICAL FIELD

The present invention relates to a method of automatically accurately measuring information about an aircraft taking off from or landing on an airport, in particular, the takeoff/landing time thereof, and a method of managing takeoff/landing of the aircraft based on the takeoff/landing time.

### BACKGROUND ART

Conventionally, the takeoff or landing time of an aircraft has been measured by visual observation by an air traffic controller according to the point in time when a wheel of the aircraft takes off from or comes into contact with the surface of the runway.

However, the time measured by the visual observation varies with various conditions including weather and hour (day or night) or with individuals. Furthermore, measurement cannot be conducted because of the positional relationship between the aircraft and the observer. Thus, the takeoff/landing time cannot be reliably measured in some cases.

The present invention provides a technique of intercepting a transponder signal transmitted from an aircraft and determining the takeoff/landing time based on a 1-bit vertical status code contained in the signal or a barometric altimeter indication value. Such a technique has not been developed yet.

### [Patent Document 1]: WO02/052526A1

[Patent Document 2]: U.S. Pat. No. 6,384,783

[Patent Document 3]: U.S. Pat. No. 6,448,929

### DISCLOSURE OF THE INVENTION

As described above, the takeoff/landing time of an aircraft is measured by human visual observation, and it is difficult to reliably determine the time accurately. Besides, in a heavy-traffic airport, the manpower burden is significant, and automation of the measurement has been desired.

The takeoff/landing time is essential for management of airport utilization, such as calculation of airport fee, and for measurement of noise around the airport. Thus, it has to be measured as accurately as possible. Furthermore, if the takeoff/landing time is automatically measured, the data can be easily processed for secondary use. From this point of view also, automation of the measurement of the takeoff/landing time has been desired.

The present invention provides:

(1) an aircraft takeoff/landing time measuring method, characterized in that airborne collision avoidance system communication signals constantly and continuously transmitted from a transponder of an aircraft in operation are intercepted, and the takeoff/landing time of the aircraft is determined according to the point in time at which a vertical status code contained in each of the signals changes to 0 or 1.

The airborne collision avoidance system (typically abbreviated as ACAS or TCAS but referred to as ACAS in this specification) installed in aircrafts is a system that allows each aircraft to constantly transmit inquiry signals at 1030 MHz to other aircrafts and receive response signals at 1090 MHz from other aircrafts, thereby automatically avoiding a midair collision.

An ACAS response signal (downlink format, referred to as DF hereinafter) of a format number 0 or 16, which corresponds to an ACAS inquiry signal (uplink format, referred to as UF hereinafter) of a format number 0 or 16, contains a 24-bit aircraft unique identifier (on which a parity code is superimposed and which is referred to as aircraft ID hereinafter), a 1-bit vertical status code (referred to as VS value hereinafter) and a 13-bit barometric altimeter indication value (referred to as AC value hereinafter) (see the field definition in FIG. 3). The present invention is implemented using these pieces of information.

Here, the aircraft ID is a globally unique identification number imparted to each aircraft, and the VS value is automatically set by the ACAS at “1” when the aircraft is on the ground and at “0” when the aircraft is in flight.

In addition, the AC value is set at the indication value of a barometric altimeter when the aircraft is in flight (that is, when the VS value is “0”) and at 0 when the aircraft is on the ground (when the VS value is “1”).

According to the present invention, a receiving antenna is installed at a position near an airport where ACAS signals transmitted from a transponder of an aircraft taking off or landing can be clearly received to receive and decrypt the communication signals, thereby obtaining time-series data about the aircraft according to the aircraft ID contained in the DF0 or DF16. For example, when the aircraft takes off, the time at which the VS value changes from “1” to “0” is detected as the takeoff time.

Similarly, at the time of landing, the time at which the VS value changes from “0” to “1” is detected as the landing time.

In addition, the present invention provides:

(2) an aircraft takeoff/landing time measuring method, characterized in that airborne collision avoidance system communication signals constantly and continuously transmitted from a transponder of an aircraft in operation are intercepted, a range of successive indication values of 0 spanning a predetermined length of time or longer is detected from time-series barometric altimeter indication values contained in the signals, and the takeoff/landing time of the aircraft is determined according to the point in time at which the indication value of 0 changes.

According to this aspect, as in the aspect (1) described above, ACAS signals of an aircraft are obtained as a time series by interception. If AC values contained in the signals successively assume 0 for a predetermined time, the time at which the first one of the successive 0s occurs is detected as the landing time when the aircraft lands, and the time at which the last one of the successive 0s occurs is detected as the takeoff time when the aircraft takes off.

According to this aspect, unlike the aspect (1) described above, the takeoff/landing time cannot be determined instantly but determined by analysis of data for a predetermined time.

This is because the AC value in the ACAS signal does not always assume a positive value and may assume zero or a negative value for a reason described later, and it can be determined that the aircraft is on the ground only from the fact that the AC values continuously assume 0 for a predetermined time. In practical, false detection of the takeoff/landing time can be avoided by setting a data analysis time of about 5 seconds.

Therefore, this aspect is particularly useful in the case where the aspect (1) described above cannot be used for some reasons.

(3) A method of calibrating the altitude indicated by a barometric altimeter, characterized in that the indicated altitude is corrected according to the AC value at the takeoff/landing time obtained by the method according to the aspect (1) or (2) described above.

As the AC values contained in the ACAS signals during flight, indication values of the barometric altimeter installed in the aircraft are used. In order to ensure effective operation of the collision avoidance function, all the aircrafts use the QNE setting, which uses the standard atmospheric pressure as a reference value, for the barometric altimeter measurements contained in the ACAS signals.

However, the flight altitude value based on the standard atmospheric pressure does not represent the flight altitude relative to the altitude of the airport, because the actual atmospheric pressure at the airport is not always equal to the standard atmospheric pressure.

However, for example, in order to grasp facts about noise of the aircraft around the airport, the accurate flight altitude has to be known. Thus, the present invention has been devised in order to determine the accurate flight altitude at the time of takeoff or landing.

Focusing on the fact that the variation of the AC values contained in the ACAS values is accurate, and the AC values are forcedly set at 0 in association with the VS values when the aircraft is on the ground, the AC value at the time of takeoff/landing in the time-series data is used as an offset (a reference point for 0) to correct the flight altitude value in the data, thereby determining the accurate flight altitude before and after takeoff or landing.

Here, the phrase “the AC value at the time of takeoff/landing” means an indication value immediately after takeoff when the aircraft takes off (see FIG. 1) and an indication value immediately before landing when the aircraft lands and used as a reference for correcting the flight altitude.

In addition, the present invention provides:

(4) a method of determining a runway used by an aircraft and the direction in which the aircraft takes off or lands based on the takeoff/landing time obtained by the method according to the aspect (1) or (2) described above and an aircraft ID and flight direction data obtained from an aircraft closest approach recognition system installed in the vicinity of a runway of an airport.

The applicant has already invented a method of recognizing the closest approach of an aircraft (see the Patent Document 1), and implementations of this invention have been already in practical use in airports. According to this method, the flight direction of an aircraft is obtained as time-series data, and since the flight direction of the aircraft can be known at an airport from the aircraft ID obtained at the same time, it is possible to determine which runway is used in which direction from the positional relationship between the runway and the recognition system. In addition, from the takeoff/landing time determined according to the aspect (1) or (2) described above, the runway in use and the takeoff or landing direction can be determined.

Typically, from the viewpoint of data analysis and utilization, it is preferred that the aircraft closest approach recognition system is installed at an end of each runway.

In addition, the present invention provides:

(5) an aircraft takeoff/landing management method, characterized in that ACAS communication signals constantly and continuously transmitted from transponders of a plurality of aircrafts in operation are intercepted and classified into signals for each aircraft according to aircraft IDs contained in the signals, thereby determining the takeoff/landing time, the temporal change in flight attitude, the runway and the flight direction of each aircraft, and

(6) the aircraft takeoff/landing management method according to the aspects (1) to (4) described above, characterized in that ACAS communication signals constantly and continuously transmitted from transponders of a plurality of aircrafts in operation are intercepted, and the aircrafts are identified by referring to an aircraft unique identification information database based on the aircraft IDs contained in the signals.

Many aircrafts takes off from and lands on one airport. To manage the takeoff and landing of the aircrafts, it is necessary to obtain the takeoff/landing times, as well as information about the runways in use, the flight directions at the time of takeoff/landing, the nationalities, the aircraft numbers and the types of the aircrafts. According to the present invention, these pieces of information about all the aircrafts using the airport can be automatically obtained.

According to the present invention, the takeoff/landing time of an aircraft can be automatically and accurately measured without fluctuations due to a weather condition or a human factor. In addition, since the obtained data is in digital form, it can be easily processed for secondary use, and the measured takeoff/landing time in conjunction with the in-use runway data, the flight direction data and the aircraft identification data obtained at the same time allows easy and quick management of the takeoff/landing of an aircraft at an airport.

### BRIEF DESCRIPTION OF THE DRAWINGS

FIG. 1 shows a plot of vertical status values (VS values) and barometric altimeter indication values (AC values) of a group of signals obtained from one aircraft taking of f versus time;

FIG. 2 is a table showing reception signal data, which serves as a basis for the graph shown in FIG. 1, with the time of receipt;

FIG. 3 shows field definitions of ACAS response signals of format numbers 0 and 16 of a transponder; and

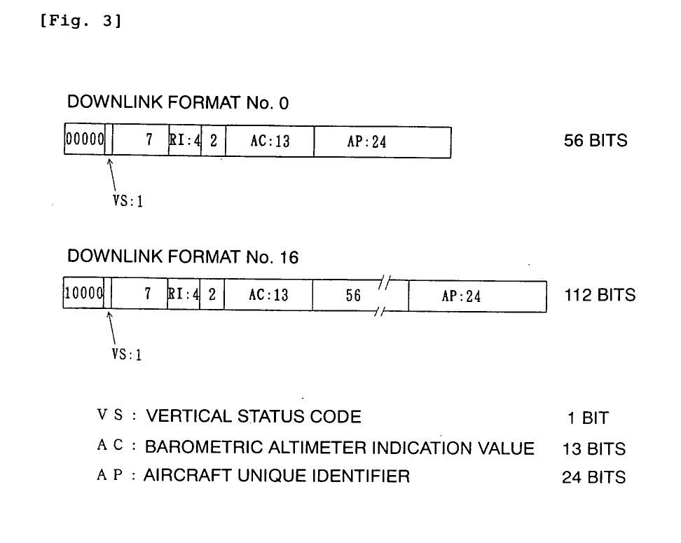

FIG. 4 is a schematic flowchart for illustrating an embodiment 2 of the present invention.

### BEST MODE FOR CARRYING OUT THE INVENTION

### Embodiment 1

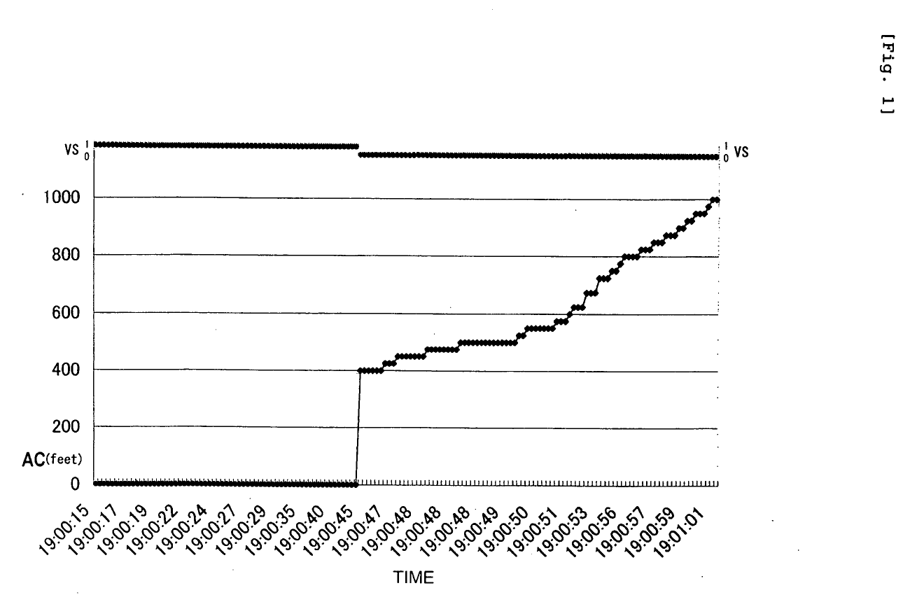

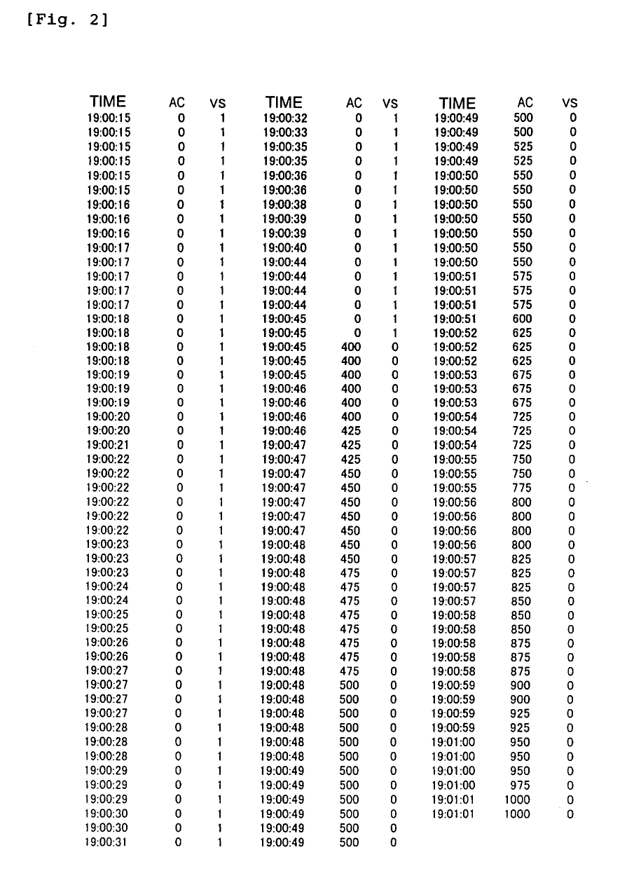

FIG. 1 shows a plot of VS values and AC values of ACAS signals transmitted from an aircraft taking off from the Narita Airport and intercepted in the vicinity thereof versus time obtained according to the present invention. FIG. 2 is a list of VS values and AC values of received ACAS signals shown with their respective times of receipt.

A barometric altimeter outputs altitude values on a 25-feet basis, and thus, the graph is stepwise.

As can be seen from FIGS. 1 and 2, the aircraft takes off at 19:00:45, at which the VS value changes from “1” to Alternatively, the takeoff time of 19:00:45 can be determined from the fact that the AC value continuously assumes 0 from a time indication of 19:00:15 to a time indication of 19:00:45 and then changes to 400 at the following time indication of 19:00:45.

The AC value of 400 feet at the time of change is used as an altitude correcting value. By subtracting 400 feet from the subsequent AC values, the actual temporal change in flight altitude after takeoff can be obtained.

Alternatively, the difference between the standard atmospheric pressure and the atmospheric pressure at the airport may be determined from the altitude correcting value, and the atmospheric pressure difference may be converted to altitude by atmospheric pressure correction, thereby more accurately calculating the flight altitude around the airport.

### Embodiment 2

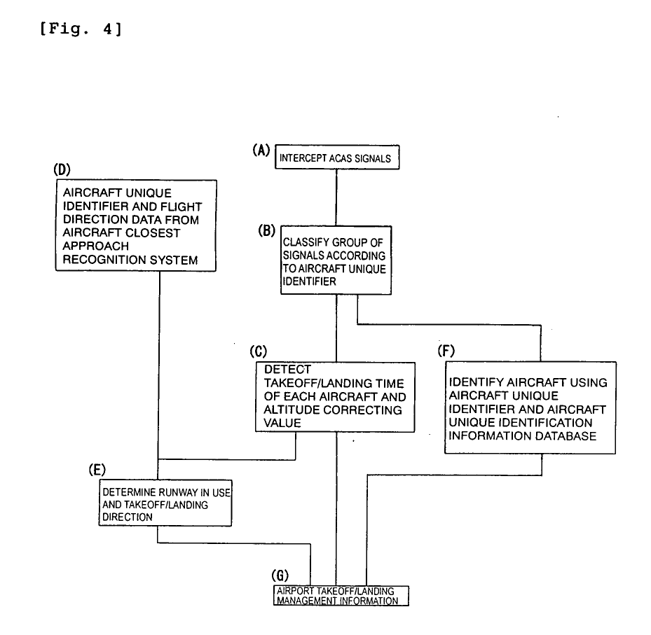

As shown in FIG. 4, according to a second embodiment of the present invention,

(A) a receiving antenna is installed at a position where ACAS signals constantly and continuously transmitted from transponders of aircrafts can be clearly received, received ACAS signals are analyzed, and only the DF0s and DF16s, as well as the times of receipt, are sequentially written/stored in a computer,

(B) the group of signals are classified according to a 24-bit aircraft ID contained in each signal and divisionally stored as aircraft data, and

(C) the classified time-series data about each aircraft, in particular, the VS value is checked over time, a point in time at which the value changes is detected as the takeoff/landing time of the aircraft, and the time is written/stored as the “takeoff time” if the value changes from “1” to “0” or as the “landing time” if the value changes from “0” to “1”. Simultaneously, the AC value in the data at the time of change of the VS value is written/stored as an altitude correcting value.

In the case where the VS value changes from “1” to “0” when the aircraft takes off, the altitude value in the data is written/stored as the altitude correcting value, and in the case where the VS value changed from “0” to “1” when the aircraft lands, the AC value in the preceding data is written/stored as the altitude correcting value.

In this way, the takeoff/landing time and the altitude correcting value of one aircraft can be obtained.

(D) Furthermore, time-series flight-direction data from an aircraft closest approach recognition system installed at an end of a runway of the airport and the aircraft unique identifier are obtained (see the Patent Document 1), and

(E) the direction in which the aircraft takes off or lands can be determined, and the takeoff/landing direction is written/stored.

If the airport has a plurality of runways, the aircraft closest approach recognition system can be installed in the vicinity of an end of each runway to determine which runway is used by an aircraft and in which direction the aircraft takes off or lands. The runway in use and the takeoff/landing direction are written/stored.

(F) Furthermore, based on the aircraft ID in the classified data, an aircraft unique identification information database is referred to identify the aircraft and obtain information about the nationality, the aircraft number, the type of the aircraft or the like, and the information is written/stored.

As described above, by the process including the steps (A), (B) and (C), the takeoff/landing time and altitude correcting value of an aircraft can be obtained, by the process including the steps (A), (B), (C), (D) and (E), the information about the runway used by the aircraft and the takeoff/landing direction data can be obtained, and by the process including the steps (A), (B) and (F), the data that identifies the aircraft can be obtained. By processing these pieces of data, takeoff/landing management information concerning an airport can be obtained in an organized and integrated manner (G).

These pieces of data may be processed in a batched manner after reception of the ACAS signals, and input and write/storage of the DF data are completed. Alternatively, the data may be processed in real time, and the information about the data processing may be displayed on a monitor screen in the control room, for example.

### INDUSTRIAL APPLICABILITY

According to the present invention, the takeoff/landing time of an aircraft at an airport can be automatically measured, and furthermore, takeoff and landing of aircrafts all over the airport can be managed accurately and efficiently using aircraft unique identifiers. Thus, the present invention contributes greatly to improvement in performance of the airline industry.

In addition, the present invention can provide basic data for measurement of environmental noise near the airport and thus is useful for environmental administration.

1. An aircraft takeoff/landing time measuring method, comprising constantly and continuously transmitting airborne collision avoidance system communication signals from a transponder of an aircraft in operation, intercepting the signals and determining takeoff/landing time of the aircraft according to a point in time at which a vertical status code contained in each of the signals changes to 0 or 1.

2. An aircraft takeoff/landing time measuring method, comprising constantly and continuously transmitting airborne collision avoidance system communication signals from a transponder of an aircraft in operation, intercepting the signals, detecting a range of successive indication values of 0 spanning a predetermined length of time or longer from time-series barometric altimeter indication values contained in the signals, and determining takeoff/landing time of the aircraft according to a point in time at which the indication value of 0 changes.

3. A method of calibrating the altitude indicated by a barometric altimeter, comprising correcting the indicated altitude according to indication value of the barometric altimeter at the takeoff/landing time obtained by a method according to claim 1 or 2.

4. A method of determining a runway used by an aircraft and the direction in which the aircraft takes off or lands, comprising basing the runway determination on the takeoff/landing time obtained by a method according to claim 1 or 2 and an aircraft unique identifier and flight direction data obtained from an aircraft closest approach recognition system installed in the vicinity of a runway of an airport.

5. An aircraft takeoff/landing management method, comprising constantly and continuously transmitting airborne collision avoidance system communication signals from trans transponders of a plurality of aircrafts in operation, intercepting the signals and classifying the signals into signals for each aircraft according to aircraft unique identifiers contained in the signals, thereby determining takeoff/landing time, temporal change in flight attitude, runway and flight direction of each aircraft.

6. The aircraft takeoff/landing management method according to claim 5, wherein aircraft is identified by referring to an aircraft unique identification information database based on the aircraft unique identifiers contained in the signals.
